(19) United States
(12) Patent Application Publication
(10) Pub. No.: US 2015/0293547 A1
(43) Pub. Date: Oct. 15, 2015

(54) VOLTAGE-CURRENT CONVERSION CIRCUIT AND POWER SUPPLY CIRCUIT

(71) Applicant: KABUSHIKI KAISHA TOSHIBA, Tokyo (JP)

(72) Inventors: Akihiro TANAKA, Fuchu Tokyo (JP); Hirokazu Kadowaki, Fujisawa Kanagawa (JP); Hideaki Miyoshi, Kawasaki Kanagawa (JP)

(21) Appl. No.: 14/475,504

(22) Filed: Sep. 2, 2014

(30) Foreign Application Priority Data
Apr. 11, 2014 (JP) 2014-082026

(51) Int. Cl. G05F 1/56

(52) U.S. Cl. CPC G05F 1/561

(57) ABSTRACT

According to one embodiment, a voltage-current conversion circuit includes an input port to which an input voltage is sent, a first transistor in which more current flows as the input voltage decreases, a second transistor in which more current flows as the input voltage increases, first current mirror circuit that mirrors increased current flowing in the first transistor to an output port, second current mirror circuit that mirrors increased current flowing in the second transistor to the output port.

### CROSS-REFERENCE TO RELATED APPLICATION

This application is based upon and claims the benefit of priority from Japanese Patent Application No. 2014-082026, filed Apr. 11, 2014, the entire contents of which are incorporated herein by reference.

### FIELD

Embodiments described herein relate generally to a voltage-current conversion circuit and a power supply circuit.

### BACKGROUND

A smartphone, a tablet or the like is driven by a battery, and to use the battery as long as possible, a power supply circuit called a low drop out (LDO) circuit is widely used to maintain battery life. However, as recent portable electronic devices, such as smartphones and tablets, or the like, are improved in performance every year, current consumption of each electronic component in the portable electronic device tends to increase. The more the current consumption of the portable electronic device increases, the more variation of output voltage of the LDO circuit increases, and in some cases, there is a possibility that the LDO circuit may not operate properly.

In order to prevent such a malfunction, a booster circuit may be connected to the LDO circuit, thereby suppressing variation of the output voltage from the LDO circuit. However, since the booster circuit also consumes current, the current consumption of the entire power supply circuit increases, and thus there is a possibility that a battery consumption increases.

### DESCRIPTION OF THE DRAWINGS

FIG. 1 is a circuit diagram of a power supply circuit including a voltage-current conversion circuit according to a first embodiment.

FIG. 2 is a circuit diagram of a differential amplifier according to a first embodiment.

FIG. 3 is a circuit diagram of the power supply circuit including a voltage-current conversion circuit according to a second embodiment.

FIG. 4 is a circuit diagram of a differential amplifier according to a second embodiment.

### DETAILED DESCRIPTION

Embodiments provide a voltage-current conversion circuit and a power supply circuit which may improve responsiveness of a current generated according to an input voltage.

In general, according to one embodiment, a voltage-current conversion circuit includes: an input port to which an input voltage is sent; a first transistor in which more current flows as the input voltage decreases; a second transistor in which more current flows as the input voltage increases; first current mirror circuitry that mirrors increased current flowing in the first transistor to an output port; second current mirror circuitry that mirrors increased current flowing in the second transistor to the output port.

Hereinafter, example embodiments are described with reference to the accompanying drawings. In the following examples, characteristic configurations and operations of the voltage-current conversion circuit and the power supply circuit are mainly described. However, configurations and operations which not specifically explained in the following description may exist in the voltage-current conversion circuit and the power supply circuit and will be apparent to those of ordinary skill in the art. These omitted configurations and operations are included in a scope of the disclosure.

### First Embodiment

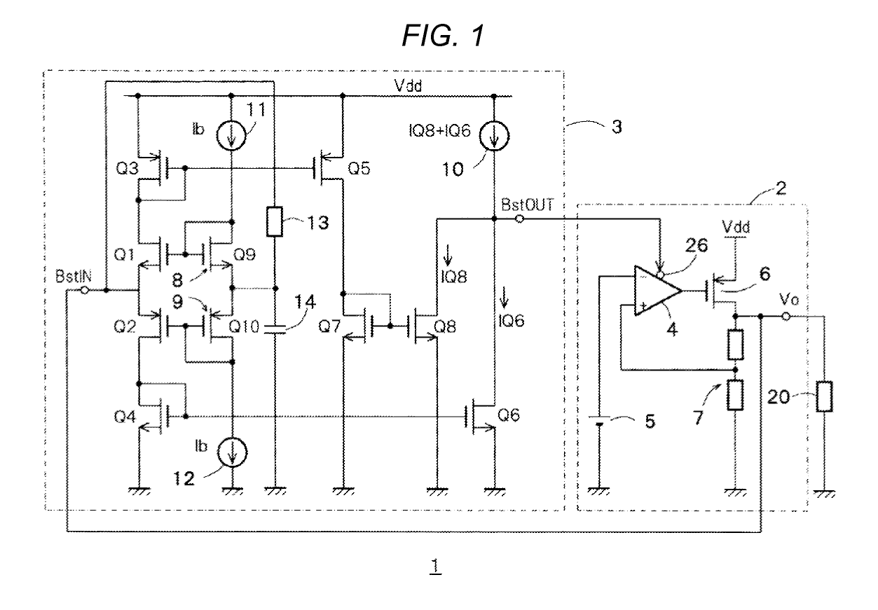

FIG. 1 is a circuit diagram illustrating a power supply circuit 1 including a voltage-current conversion circuit according to a first embodiment. The power supply circuit 1 of FIG. 1 includes an LDO circuit 2 and a low consumption booster circuit 3. The LDO circuit 2 is a DC voltage generating circuit with feedback such that an output voltage is related to a reference voltage. The output voltage Vo of the LDO circuit 2 is supplied to a load 20. The low consumption booster circuit 3 is a voltage-current conversion circuit which generates a current signal for adjusting the response characteristics of the LDO circuit 2.

The LDO circuit 2 includes a first-stage amplifier 4, a battery 5, a PMOS transistor (feedback transistor) 6, and a voltage dividing circuit 7. The voltage dividing circuit 7 generates a voltage related to the output voltage of the LDO circuit 2, that is, the voltage dividing circuit 7 generates a divided voltage related to the output voltage which is supplied as input to the first-stage amplifier 4. The battery 5 outputs a reference voltage. The first-stage amplifier 4 generates a signal according to a difference voltage between the reference voltage and the divided voltage. This signal is input to a gate of the PMOS transistor 6 which thus outputs, from a drain terminal of the PMOS transistor 6, a voltage according to an output signal of the first-stage amplifier 4. This voltage becomes the output voltage of the LDO circuit 2.

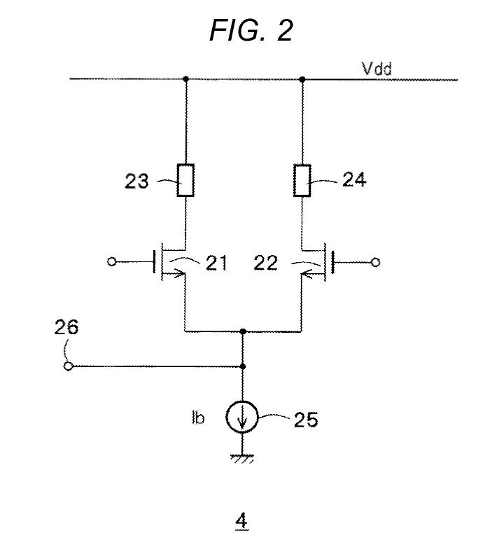

The first-stage amplifier 4 is a differential amplifier, and is configured with a circuit such as that illustrated in FIG. 2, for example. The differential amplifier of FIG. 2 includes a pair of NMOS transistors 21 and 22, an impedance element 23, which is inserted between a drain of the NMOS transistor 21 and a power supply voltage node Vdd, an impedance element 24, which is inserted between a drain of the NMOS transistor 22 and the power supply voltage node Vdd, a current source 25, which is connected between sources of the NMOS transistors 21 and 22 and a ground node, and a current adjustment port (a first port) 26.

The current adjustment port 26 is connected to a junction of the sources of a pair of NMOS transistors 21 and 22 and the current source 25. A current flowing in the first-stage amplifier 4 is varied by a current flowing in the current adjustment port 26, thereby adjusting the speed of response of the first-stage amplifier 4, and thus, a frequency characteristic of the first-stage amplifier 4 may be adjusted. That is, as illustrated in FIG. 2, the differential amplifier is installed in the first-stage amplifier 4, and if a current flowing from the current adjustment port 26 of the first-stage amplifier 4 into the low consumption booster circuit 3 increases, the current flowing in the differential amplifier in the first-stage amplifier 4 also increases, and a capability (speed) of the differential amplifier to charge or discharge agate capacitance of a PMOS transistor 6 connected to an output node of the first-stage amplifier 4 is improved. This means that the frequency and response characteristic of the first-stage amplifier 4 is improved.

The low consumption booster circuit 3 includes an input port BstIN, an output port BstOUT, first to eighth transistors Q1 to Q8, a first bias circuit 8, a second bias circuit 9, and a first current source 10. The output voltage Vo of the LDO circuit 2 is input to the input port BstIN. The current flowing in the output port BstOUT flows into the current adjustment port 26 of the LDO circuit 2. Hereinafter, a current flowing between the drain and the source of a transistor is simply referred to as a current flowing in a transistor.

A source of a first transistor Q1 configured with an NMOS transistor and a source of a second transistor Q2 configured with a PMOS transistor are connected together to the input port BstIN of the low consumption booster circuit 3. The first bias circuit 8 supplies a bias voltage to a gate of the first transistor Q1. The first bias circuit 8 includes a ninth transistor Q9 which is configured with an NMOS transistor with a gate connected to a gate of the first transistor Q1, and a second current source 11 which supplies a bias current to the ninth transistor Q9. The second bias circuit 9 supplies a bias voltage to a gate of the second transistor Q2. The second bias circuit 9 includes a tenth transistor Q10 which is configured with a PMOS transistor with a gate connected to a gate of the second transistor Q2, and a third current source 12 which supplies a bias current to the tenth transistor Q10. Each source of the ninth transistor Q9 and the tenth transistor Q10 is connected to one end of a capacitor 14. The other end of the capacitor 14 is connected to the ground node, and an impedance element 13 is connected between the one end of the capacitor 14 and the input port BstIN of the low consumption booster circuit 3.

In addition, a circuit configuration of the first bias circuit 8 and the second bias circuit 9 is not limited to a circuit illustrated in FIG. 1. That is, the first bias circuit 8 may be a circuit which supplies a fixed bias voltage to the gate of the first transistor Q1. Similarly, the second bias circuit 9 may be a circuit which supplies a fixed bias voltage to the gate of the second transistor Q2. In addition, a bias voltage which is supplied to the gate of the first transistor Q1 and a bias voltage which is supplied to the gate of the second transistor Q2 have voltage levels different from each other.

A drain of the third transistor Q3 configured with a PMOS transistor is connected to a drain of the first transistor Q1, and the third transistor Q3 causes a current to flow according to the current flowing in the first transistor Q1. A drain of a fourth transistor Q4 configured with an NMOS transistor is connected to a drain of the second transistor Q2, and the fourth transistor Q4 causes a current to flow according to the current flowing in the second transistor Q2.

A fifth transistor Q5 configured with a PMOS transistor operates together with the third transistor Q3 to form a current mirror circuit, and the fifth transistor Q5 mirrors the current flowing in the third transistor Q3.

A sixth transistor Q6 configured with an NMOS transistor together with the fourth transistor Q4 forms a current mirror circuit, and the sixth transistor Q6 mirrors the current flowing in the fourth transistor Q4.

A drain of the sixth transistor Q6 is connected to the output port BstOUT of the low consumption booster circuit 3 and a first current source 10.

A drain of the fifth transistor Q5 is connected to a drain of a seventh transistor Q7 configured with an NMOS transistor, and the seventh transistor Q7 causes a current to flow according to the current flowing in the fifth transistor Q5. A gate of an eighth transistor Q8 configured with an NMOS transistor and a gate of the seventh transistor Q7 are connected together, and the eighth transistor Q8 mirrors the current flowing in the seventh transistor Q7. A drain of the eighth transistor Q8 is connected to the output port BstOUT of the low consumption booster circuit 3.

The first to third current sources 10 to 12 in the low consumption booster circuit 3 supply a minimum current (for example, approximately several nano-amperes) required for operating the first to tenth transistors Q1 to Q10, and when the output voltage Vo of the LDO circuit 2 is suddenly changed by a variation (hereinafter, load variation) of current consumed by the load 20, the current flowing in the output port BstOUT has a value determined by an amount of change of the output voltage Vo and by a response characteristic of the first or second transistor Q1 or Q2, only when the output voltage Vo is changed. That is, each gate of the first and second transistors Q1 and Q2 has a fixed voltage at a normal state, and the low consumption booster circuit 3 does not operate. When the low consumption booster circuit 3 does not operate, the current of the first current source 10 is set so as to be equal to a sum (IQ6+IQ8) of a current IQ6 flowing in the sixth transistor Q6 and a current IQ8 flowing in the eighth transistor Q8. Thus, when the low consumption booster circuit 3 does not operate, no current is transferred into or out of the output port BstOUT of the low consumption booster circuit 3. In contrast, if the output voltage Vo of the LDO circuit 2 changes, a gate-to-source voltage of the first transistor Q1 or the second transistor Q2 changes, and a current flowing in the first transistor Q1 or the second transistor Q2 increases. A value of the current flowing in the first transistor Q1 or the second transistor Q2 is a value determined by a voltage level of the output voltage Vo which is supplied to the sources of the transistors Q1 and Q2, and by resistance between the gates and the sources of the transistors Q1 and Q2. If the current flowing in the first transistor Q1 or the second transistor Q2 increases, the current flowing in the sixth transistor Q6 or the eighth transistor Q8 increases, but the increased current is not supplied by the first current source 10, and thus a current is supplied via the current adjustment port 26 of the first-stage amplifier 4 in the LDO circuit 2.

The operation of the power supply circuit 1 of FIG. 1 is next described. The LDO circuit 2 of FIG. 1 normally operates with the current consumption of several dozen micro-amperes or less. However the load which is driven by the LDO circuit 2 may suddenly change to several hundred milli-amperes in a very short time, on the order of micro-seconds. According to this load change, the output voltage Vo of the LDO circuit 2 greatly changes in a short time. For example, if the output voltage Vo of the LDO circuit 2 suddenly decreases from the normal operating state, an input voltage of the input port BstIN of the low consumption booster circuit 3 decreases, and as a result, a source voltage of the first transistor Q1 decreases, and the first transistor Q1 causes more current to flow. As a result, the current flowing in the third transistor Q3 also increases, and the current flowing in the fifth transistor Q5 which configures the current mirror circuit together with the third transistor Q3 also increases. A drain of the fifth transistor Q5 is connected to a drain of the seventh transistor Q7, and a gate of the seventh transistor Q7 and a gate of the eighth transistor Q8 are connected together, and thus, if the current flowing in the fifth transistor Q5 increases, the currents flowing in the seventh transistor Q7 and the eighth transistor Q8 also increase. The current flows such that more current is drawn (flows) from the output port BstOUT of the low consumption booster circuit 3 to the eighth transistor Q8. The output port BstOUT is connected to the current adjustment port 26 of the first-stage amplifier 4 in the LDO circuit 2, and more current flows from the current adjustment port 26 to the eighth transistor Q8 via the output port BstOUT. Thus, the current flowing in the first-stage amplifier 4 increases, an operation speed of the first-stage amplifier 4 is improved, and a capability (speed) of charging or discharging the gate capacitance of the sixth transistor Q6 connected to the output node of the first-stage amplifier 4, is improved. This means that the frequency characteristic and responsiveness of the first-stage amplifier 4 are improved. Thus, so as to suppress a decrease of the output voltage Vo, the LDO circuit 2 rapidly performs an operation of increasing the output voltage Vo.

Conversely, if the output voltage Vo of the LDO circuit 2 suddenly increases from the normal operating state, an input voltage of the input port BstIN of the low consumption booster circuit 3 increases, and as a result, a source voltage of the second transistor Q2 increases, and the current flowing in the second transistor Q2 increases. As a result, the current flowing in the fourth transistor Q4 also increases, and the current flowing in the sixth transistor Q6 which configures the current mirror circuit together with the fourth transistor Q4 also increases. A drain of the sixth transistor Q6 is connected to the output port BstOUT of the low consumption booster circuit 3, and more current is drawn from the output port BstOUT and flows to the sixth transistor Q6. Thus, in the same manner as the decreased output voltage Vo, more current flows from the current adjustment port 26 of the first-stage amplifier 4 in the LDO circuit 2 to the output port BstOUT, and the frequency characteristic and responsiveness of the first-stage amplifier 4 are improved. Thus, in order to suppress the increase of the output voltage Vo, the LDO circuit 2 rapidly decreases the output voltage Vo.

In this way, in the first embodiment, if the output voltage Vo of the LDO circuit 2 varies, the current according to the output voltage Vo is rapidly generated in the low consumption booster circuit 3 according to the variation, and the current is drawn from the current adjustment port 26 of the first-stage amplifier 4 in the LDO circuit 2 to the sixth transistor Q6 or the eighth transistor Q8 in the low consumption booster circuit 3 via the output port BstOUT. As a result, the current flowing in the first-stage amplifier 4 increases, the capability (speed) of the first-stage amplifier 4 to charge or discharge the gate capacitance of the PMOS transistor 6 is improved. This means that the frequency characteristic and responsiveness of the first-stage amplifier 4 are improved, and the variation of the output voltage Vo of the LDO circuit 2 maybe rapidly suppressed. The first to third current sources 10 to 12 in the low consumption booster circuit 3 consume a minimum current required for operating the first to tenth transistors Q1 to Q10, and only when the output voltage Vo of the LDO circuit 2 varies, does the current determined by an amount of the variation and the response characteristic of the first or second transistor Q1 or Q2 temporarily flow. Thus, the low consumption booster circuit 3 may be operated by only an extremely small bias current, and without increasing the current consumption of the LDO circuit 2 of a low power consumption and the whole of the power supply circuit 1, the variation of the output voltage Vo maybe suppressed such that the responsiveness is improved, and the LDO circuit 2 may stably operate.

In addition, the output port BstOUT of the low consumption booster circuit 3 is connected to the current adjustment port 26 of the first-stage amplifier 4 in the LDO circuit 2. Since the current adjustment port 26, as illustrated in FIG. 2, is connected to sources of a pair of NMOS transistors 21 and 22 of the differential amplifier which configures the first-stage amplifier 4, there is an effect that an offset current of the low consumption booster circuit 3 has less negative influence on the operation of the LDO circuit 2. That is, although the low consumption booster circuit 3 includes the second current source 11 connected to the power supply voltage node Vdd and the third current source 12 connected to the ground node, but there is a case where the current flowing in the second current source 11 is not equal to the current flowing in the third current source 12 due to manufacturing variation or the like. In this case, a current is drawn from the output port BstOUT and output, and then becomes an offset current. However, in this embodiment, the offset current only slightly increases or decreases the current flowing in the sources of a pair of NMOS transistors 21 and 22 of the differential amplifier via the current adjustment port 26 of the first-stage amplifier 4 in the LDO circuit 2, and has less negative influence on the operation of the LDO circuit 2.

### Second Embodiment

Although the first embodiment described above uses a differential amplifier in which the first-stage amplifier 4 in the LDO circuit 2 are NMOS transistors, it is also possible to use a differential amplifier in which the first-stage amplifier 4 in the LDO circuit 2 has PMOS transistors. This may be preferable in some contexts because a requirement of lowering a voltage level of the battery 5 which is connected to the first-stage amplifier 4 has been recently increasing. Generally, when the voltage level of the battery 5 which is connected to the first-stage amplifier 4 is less than 0.5 V, configuring the first-stage amplifier 4 using the NMOS transistors is not easy, and configuring the first-stage amplifier 4 using the PMOS transistors is necessary. Therefore, the second embodiment described below exemplifies the differential amplifier in which the first-stage amplifier 4 in the LDO circuit 2 uses the PMOS transistors.

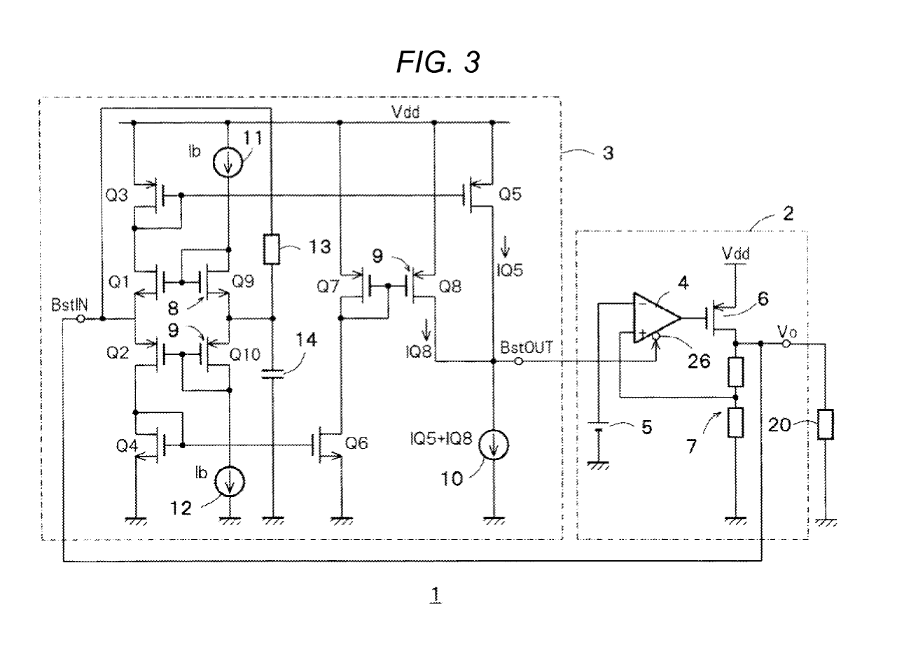

FIG. 3 is a circuit diagram of the power supply circuit 1 according to the second embodiment. In FIG. 3, the same reference numerals and symbols are assigned to the components corresponding to those in FIG. 1, and hereinafter, the differences will be mainly described.

The LDO circuit 2 in FIG. 3 is different from the LDO circuit 2 in FIG. 1 in that a conductivity type of the first-stage amplifier 4 is changed from the NMOS transistor to the PMOS transistor.

The low consumption booster circuit 3 in FIG. 3 is different from that in FIG. 1 in that the output port BstOUT and the first current source 10 are connected to the drain of the fifth transistor Q5, and the drain of the seventh transistor Q7 is connected to the drain of the sixth transistor Q6.

In addition, the low consumption booster circuit 3 in FIG. 3, when the output voltage Vo of the LDO circuit 2 varies, outputs a current to the current adjustment port 26 of the first-stage amplifier 4 in the LDO circuit 2 from the output port BstOUT. That is, a direction of the current flowing in the output port BstOUT is different from that in FIG. 1.

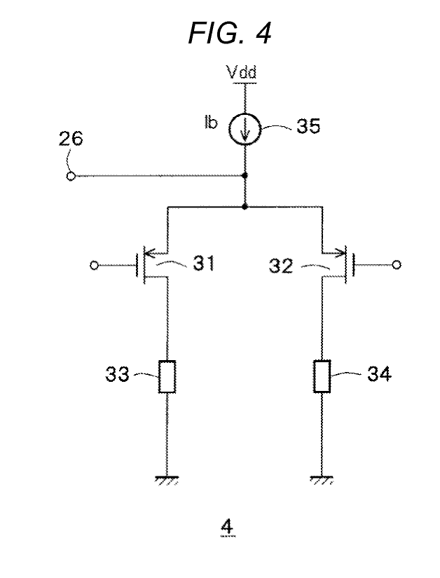

FIG. 4 illustrates a circuit diagram of a differential amplifier which configures the first-stage amplifier 4. The differential amplifier in FIG. 4 includes a pair of PMOS transistors 31 and 32, impedance elements 33 and 34 which are respectively inserted between drains of the PMOS transistors 31 and 32 and the ground node, and a current source 35 which is inserted between sources of the PMOS transistors 31 and 32 and the power supply voltage node Vdd. The current adjustment port 26 is connected to a junction of the current source 35 and the sources of the PMOS transistors 31 and 32.

The operation of the power supply circuit 1 in FIG. 3 is next described. If the output voltage Vo of the LDO circuit 2 is suddenly decreased by the load variation, the current flowing in the first transistor Q1 in the low consumption booster circuit 3 increases, the current increases in a sequence of the third transistor Q3 and the fifth transistor Q5, and then the current flowing from the output port BstOUT to the current adjustment port 26 of the first-stage amplifier 4 in the LDO circuit 2 increases. As a result, the frequency characteristic of the first-stage amplifier 4 is improved, the responsiveness of the LDO circuit 2 is improved, and an operation of rapidly pulling up the output voltage Vo is performed.

In contrast, if the output voltage Vo of the LDO circuit 2 is suddenly increased by the load variation, the current flowing in the second transistor Q2 in the low consumption booster circuit 3 increases, the current increases in a sequence of the fourth transistor Q4, the sixth transistor Q6, the seventh transistor Q7, and the eighth transistor Q8, and then the current flowing from the output port BstOUT to the current adjustment port 26 of the first-stage amplifier 4 in the LDO circuit 2 increases. As a result, the frequency characteristic of the first-stage amplifier 4 is improved, the responsiveness of the LDO circuit 2 is improved, and an operation of rapidly pulling down the output voltage Vo is performed.

In this way, in the second embodiment, even if the first-stage amplifier 4 in the LDO circuit 2 is configured with the PMOS transistors, when the output voltage Vo of the LDO circuit 2 varies, the current flowing from the output port BstOUT to the current adjustment port 26 of the first-stage amplifier 4 may be increased, without increasing the current consumption in the low consumption booster circuit 3. Accordingly, the frequency characteristic of the first-stage amplifier 4 is improved, the LDO circuit 2 operates rapidly, and thereby the variation of the output voltage Vo may be reduced.

Although the first and second embodiments described above use MOS transistors in the low consumption booster circuit 3 and in the first-stage amplifier 4 in the LDO circuit 2, bipolar transistors may be used instead of the MOS transistors. In addition, the conductivity type of each transistor in the low consumption booster circuit 3 illustrated in FIGS. 1 to 3 maybe reversed. Similarly, the PMOS transistor 6 in the LDO circuit 2 may also be configured with the NMOS transistor. Furthermore, the LDO circuit 2 and the low consumption booster circuit 3 in FIGS. 1 to 3 illustrate only important circuit components, and various active components or passive components which are not specifically illustrated may be appropriately added thereto.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voltage-current conversion circuit, comprising:
a first transistor in which more current flows as an input voltage at an input port decreases;
a second transistor in which more current flows as the input voltage at the input port increases;
a first current mirror circuitry that mirrors current flowing in the first transistor to an output port; and
a second current mirror circuitry that mirrors current flowing in the second transistor to the output port.

2. The voltage-current conversion circuit according to claim 1, wherein the first current mirror circuitry includes a third and a fifth transistor, the third transistor mirroring current flowing in the first transistor to the fifth transistor.

3. The voltage-current conversion circuit according to claim 1, wherein the second current mirror circuitry includes:
a fourth and a sixth transistor, the fourth transistor mirroring current flowing in the second transistor to the sixth transistor; and
a seventh and an eighth transistor, the seventh transistor mirroring current flowing in the sixth transistor to the eighth transistor.

4. The voltage-current conversion circuit according to claim 1, wherein the first current mirror circuitry includes:
a third and a fifth transistor, the third transistor mirroring current flowing in the first transistor to the fifth transistor; and
a seventh and an eighth transistor, the seventh transistor mirroring current flowing in the fifth transistor to the eighth transistor.

5. The voltage-current conversion circuit according to claim 1, wherein the second current mirror circuitry includes a fourth and a sixth transistor, the fourth transistor mirroring current flowing in the second transistor to the sixth transistor.

6. The voltage-current conversion circuit according to claim 1, wherein a source or an emitter of the first transistor and a source or an emitter of the second transistor are connected to the input port.

7. The voltage-current conversion circuit according to claim 1, further comprising:
a first current source connected to the output port, the first current source providing current to the output port such that no current flows into or out of the output port when the input voltage at the input port does not change.

8. The voltage-current conversion circuit according to claim 1, wherein
the first bias circuit includes:
a ninth transistor that causes a current to flow according to the current flowing in the first transistor, and
a second current source that supplies a bias current to the ninth transistor; and
the second bias circuit includes:
a tenth transistor that causes a current to flow according to the current flowing in the second transistor, and
a third current source which supplies a bias current to the tenth transistor.

9. The voltage-current conversion circuit according to claim 1, further comprising:
a first bias circuit that supplies a first bias voltage to a control input of the first transistor; and
a second bias circuit that supplies a second bias voltage to a control input of the second transistor, wherein
the first bias circuit is connected between a first reference voltage and the second bias circuit, and the second bias circuit is connected between the first bias circuit and a second reference voltage.

10. The voltage-current conversion circuit according to claim 9, further comprising a resistor and capacitor connected in series between the input port and the second reference voltage, a junction of the resistor and capacitor being connected to a node between the first and second bias circuits.

11. The voltage-current conversion circuit according to claim 1, wherein the voltage conversion circuit generates a current signal that is provided to a DC voltage generating circuit and the current signal adjusts a frequency characteristic of the DC voltage generating circuit.

12. A power supply circuit, comprising:
a first transistor in which more current flows as an output voltage provided at an input port decreases;
a first bias circuit that supplies a bias voltage to a gate or a base of the first transistor;
a second transistor in which more currents flows as the output voltage provided an the input port at the increases;
a second bias circuit that supplies a bias voltage to a gate or a base of the second transistor;
a first current mirror that includes:
a third transistor in which a current flows according to the current flowing in the first transistor, and
a fifth transistor in which a current flows according to the current flowing in the third transistor;
a second current mirror that includes:
a fourth transistor in which a current flows according to the current flowing in the second transistor, and
a sixth transistor in which a current flows according to the current flowing in the fourth transistor; and
an output port at which a current signal is supplied according to the current flowing in the fifth transistor and the sixth transistor, wherein
the sixth transistor is connected between the output port and a ground potential.

13. The power supply circuit according to claim 12, further comprising a first current source connected to the output port, wherein
the first current source provides a current to the output port such that no current flows into or out of the output port when the input voltage does not change.

14. The power supply circuit according to claim 12, further including:
an inverting transistor and a voltage divider connected in series between a first reference voltage and a second reference voltage, the inverting transistor having a gate or base controlled by an output of a differential amplifier that compares the reference voltage to a divided voltage from the voltage divider to control the inverting transistor, the inverting transistor providing the output voltage.

15. A power supply circuit, comprising:
a first transistor in which more current flows as an output voltage provided at an input port decreases;
a first bias circuit that supplies a first bias voltage to the gate or the base of the first transistor;
a second transistor in which more current flows as the output voltage provided at input port increases;
a second bias circuit that supplies a second bias voltage to the gate or the base of the second transistor;
a first current mirror that includes:
a third transistor in which a current flows according to the current flowing in the first transistor, and
a fifth transistor in which a current flows according to the current flowing in the third transistor;
a second current mirror that includes:
a fourth transistor in which a current flows according to the current flowing in the second transistor, and
a sixth transistor in which a current flows according to the current flowing in the fourth transistor; and
an output port at which a current signal is supplied according to the current flowing in the fifth transistor and the sixth transistor, wherein
the fifth transistor is connected between a first power supply voltage and the output port.

16. The power supply circuit according to claim 15,
wherein the voltage-current conversion circuit includes a current source connected to the output port, and
the current source provides current to the output port such that no current flows into or out of the output port when the output voltage does not change.

17. The power supply circuit according to claim 15, further comprising:
a DC voltage generating circuit including:
a differential amplifier that includes a first port connected to the output port, and
a feedback transistor that receives an output signal of the differential amplifier and outputs the output voltage,
the differential amplifier including:
a pair of NMOS transistors; and
a fourth current source that causes a bias current to flow into sources of the NMOS transistors, wherein
the current signal is supplied from a junction node of sources of the pair of NMOS transistors and the fourth current source to the output port.

18. The power supply circuit according to claim 17, wherein the fourth current source connected to the output port supplies current to the output port.

19. The power supply circuit according to claim 15, further comprising:
a DC voltage generating circuit including:
a differential amplifier that includes a first port connected to the output port, and
a feedback transistor that receives an output signal of the differential amplifier and outputs the output voltage,
the differential amplifier including:
a pair of PMOS transistors; and
a fifth current source that causes a bias current to flow into sources of the PMOS transistors, and
wherein the current signal is supplied from the output port to a junction node of sources of the pair of PMOS transistors and the fifth current source.

20. The power supply circuit according to claim 19, wherein the fifth current source connected to the output port, the fifth current source sinking current from the output port.
